(19) United States
(12) Patent Application Publication
(10) Pub. No.: US 2008/0236764 A1
(43) Pub. Date: Oct. 2, 2008

(54) Heavy window covering

(76) Inventor: Li-Ming Cheng, Kaohsiung City (TW)

Correspondence Address: Joe McKinney Muncy, PO Box 1364, Fairfax, VA, 22038-1364, US

(21) Appl. No.: 11/730,528

(22) Filed: Apr. 2, 2007

(51) Int. Cl. E06B 9/06

(52) U.S. Cl. 160/84.02

(57) ABSTRACT

The present invention is related to an improvement of heavy window covering including an upper elongated member, a lower elongated member, a blind-rope set, an electric transmission module, and an auto-folding device, wherein the electric transmission module includes a motor mounted inside the upper elongated member and decelerate set. The connection between a mechanical device at one side of the decelerate set and one side of the folding spring set inside the auto folding device achieves a synchronous turning, so that the auto folding device can assist the motor of the electric transmission module in folding the window covering so as to effectively reduce the loading of motor, and furthermore, when unfolding the heavy window covering, the weight of the window covering also can help reducing the motor loading.

### FIELD OF THE INVENTION

The present invention is related to an improvement of heavy window covering, and more particularly to a heavy window covering which utilizes an electric transmission module and an auto folding device to produce a synchronous turning to control the movement of blinds so as to provide the user the convenience in folding and unfolding of the blinds.

### BACKGROUND OF THE INVENTION

In the market, there are several window covering structures, such as Venetian blinds, Pleated blind, Roman blinds, etc., which are installed at the window for light block and decoration. According to different demands, the common window coverings can be divided into two kinds, the window covering controlled by rope and the electric window covering. The main structure of the electric window covering includes an upper elongated member, foldable blind set mounted under the upper elongated member, a lower elongated member mounted under the blind set, and an electric transmitter, including electronic control module, motor, gear set and transmission shaft, installed inside the upper elongated member, wherein the transmission shaft is connected to the rope so as to control the folding and unfolding speed of blind set by using the motor and the gear set.

However, if the window covering becomes heavier due to material change, the loading of motor becomes higher which might damage the motor more easily and also reduces the lifespan of window covering. Furthermore, since the electricity consumption of heavy window covering is much higher, the battery which is used as the power source must be exchanged frequently. Consequently, the conventional heavy window covering still has some inconveniences which should be improved.

### SUMMARY OF THE INVENTION

The present invention provides an improvement of heavy window covering for solving the problem of motor overloading when folding the heavy window covering, and through a mechanical device, the electric transmission module and the auto folding device can be connected, so that the electric transmission module and the auto folding device can transmit synchronously so as to provide convenience to the user for controlling the folding and unfolding of the heavy window covering.

For achieving the object describe above, the present invention provides an improvement of heavy window covering including an upper elongated member, a lower elongated member, a blind-rope set, an electric transmission module, and an auto-folding device, wherein the a blind-rope set is mounted between the separated upper and lower elongated members, and the electric transmission module includes a motor mounted inside the upper elongated member and a decelerate set, and through gear set, belt pulley set, or sprocket set, a first turning shaft of the decelerate set can be connected with a second turning shaft of the folding spring set inside the auto folding device, so that the electric transmission module and the auto folding device can have a synchronous turning.

Through the structure of window covering described above, the efficiencies are: first, when folding the heavy window covering, which is produced due to the difference of material, through the synchronous turning between the electric transmission module and the auto folding device formed via the connection achieved by the gear set, the belt pulley set and the sprocket set, the auto folding device can assist the electric transmission module in folding the window covering so as to effectively reduce the loading of motor; and secondly, when unfolding the heavy window covering, the weight of the window covering can help reducing the motor loading and also the power consumption.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a three-dimensional appearance drawing of the present invention;

FIG. 2 is a top view showing the module of the present invention;

FIG. 3 is a front view showing the module of the present invention;

FIG. 4 is a three-dimensional appearance drawing of another embodiment according to the present invention;

FIG. 5 is a top view showing the module of FIG. 4;

FIG. 6 is a front view showing the module of FIG. 4;

FIG. 7 is top view showing the module of still another embodiment according to the present invention; and

### DESCRIPTION OF THE PREFERRED EMBODIMENT

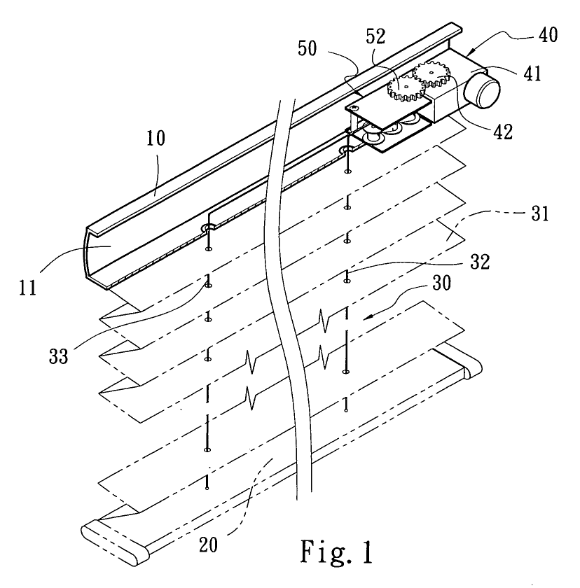

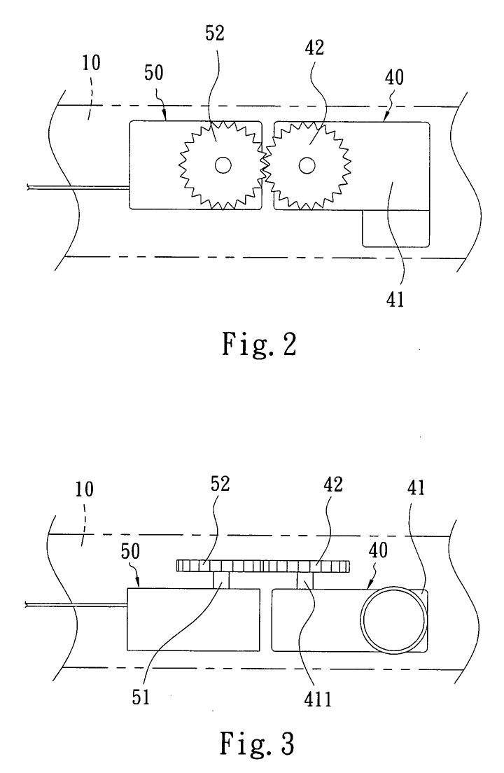

Please refer to FIG. 1 and FIG. 2, the heavy window covering of the present invention includes an upper elongated member 10, a lower elongated member 20, a blind-rope set 30, an electric transmission module 40 and an auto-folding device 50, wherein:

The upper elongated member 10 is a hollow rectangular elongated member seat and has openings 11 respectively located on two ends thereof.

The lower elongated member 20 is a hollow rectangular elongated member seat separately mounted below the upper elongated member and has openings (not shown) respectively located on two ends thereof.

The blind-rope set 30 is mounted between the upper elongated member 10 and the lower elongated member 20 and includes blinds 31, and a rope set 32, wherein the blinds 31 can be Venetian blinds, pleated blinds, or honeycomb shades. As shown, in the embodiment, the blinds 31 are Venetian blinds which are respectively connected to the upper elongated member 10 and the lower elongated member 20, and further, the rope set 32 is used to string the blinds 31 and has one end connected to the lower elongated member 20 and the other end stretched into the interior of the auto folding device 50.

Further refer to FIG. 2 and FIG. 3, the electric transmission module 40 is mounted inside the upper elongated member 10 and mainly includes a motor 41 and a decelerate set (not shown), wherein the motor 41 is fixedly connected to a gear 42 via a first turning shaft 411 at one side of the decelerate set, and through the gear 42 meshing with a gear 52, which is fixedly connected a second turning shaft 51 at one side of the folding spring set (not shown) inside the auto folding device 50, a synchronous turning at opposite directions can be achieved.

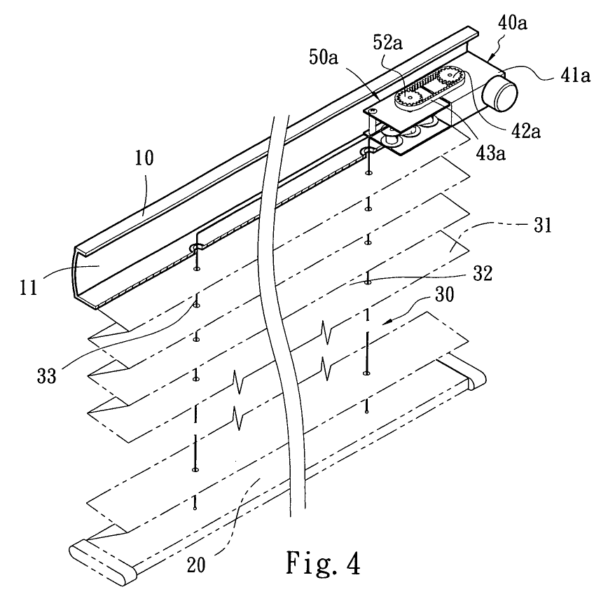

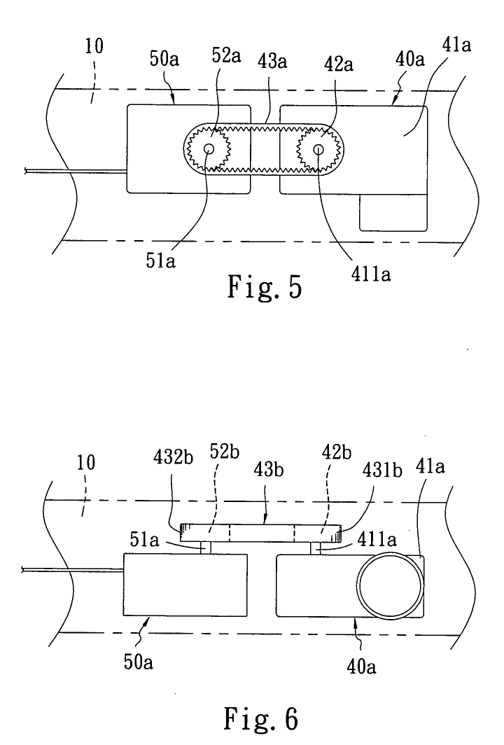

Moreover, please refer to FIG. 4 and FIG. 5. The electric transmission module 40a can include a motor 41a, decelerate set (not shown), and connecting element 43a, wherein the motor 41a is fixedly connected to a first transmission wheel 42a via a first turning shaft 411a at one side of the decelerate set, and through the first transmission wheel 42a utilizing the connecting element 43a to connect with a second transmission wheel 52a, which is fixedly connected to a second turning shaft 51a at one side of the folding spring set (not shown) inside the auto folding device 50a, a synchronous turning at same directions can be achieved.

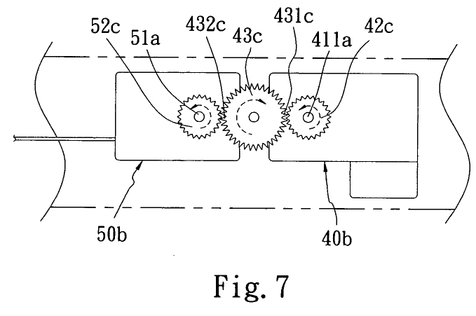

Furthermore, please refer to FIG. 5. The connecting element 43a can be a belt, a gear, a chain . . . etc., which owns the property of transmission, and the first transmission wheel 42a and the second transmission wheel 52a can be belt pulleys, gears, sprockets, etc. When the connecting element 43a is implemented as the belt, as shown in FIG. 6, one end 431b of the belt is toward the outer edge of the first belt pulley 42b, which is located at the first turning shaft 411a at one side of the decelerate set, and the other end 432b is toward the outer edge of the second belt pulley 52b, which is located at the second turning shaft 51a of the folding spring set inside the auto folding device 50a, thereby the connecting element 43b can indeed provide a mutual connecting between the second belt pulley 52b at one end of the auto folding device 50a and the first belt pulley 42b at one end of the electric transmission module 40a. When the connecting element 43c is implemented as a gear, as shown in FIG. 7, one end 431c of the gear meshes with the first gear 42c, which is located at the first turning shaft 411a at one side of the decelerate set, and the other end 432c of the gear meshes with the second gear 52c, which is located at the second turning shaft 51a at the folding spring set inside the auto folding device 50a, thereby the connecting element 43c can indeed provide a mutual connecting between the second gear 52c at one end of the auto folding device 50a and the first gear 42c at one end of the electric transmission module 40a.

According to the present invention, when folding the heavy window covering, which is produced due to the difference of material, the user can utilize the interaction between the electric transmission module 40, 40a and the auto folding device 50, 50a which is achieved by the mutual mesh between the first and the gears 42, 52, or the synchronous turning between the first and the second transmission wheels 42a, 52a achieved by the connecting element 43a, so that the auto folding device 50, 50a can assist the electric transmission module 40, 40a in folding the window covering so as to effectively reduce the loading of motor 41, 41a. Furthermore, when unfolding the heavy window covering, the weight of the window covering can help reducing the motor loading.

Consequently, through the operation described above, the user can effectively control the folding and unfolding of the heavy window covering so as to solve the known operating problems (of uneasily folded window covering, overloaded motor, and easily damaged motor) of heavy window covering caused by the material difference and also save the power consumption.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An improvement of a heavy window covering, comprising:
an upper elongated member, being a hollow rectangular elongated member seat;
a lower elongated member, being the hollow rectangular elongated member seat separately mounted below the upper elongated member;
an electric transmission module, mounted inside the upper elongated member and comprising a motor and a decelerate set, which has a first turning shaft;
an auto folding device mounted inside the upper elongated member and comprising a folding spring set, which has a second turning shaft; and
a blind-rope set, mounted between the upper elongated member and the lower elongated member and comprising blinds connected to the upper elongated member and the lower elongated member, and a rope set whose one end is connected to the lower elongated member and the other ends is stretched into the auto folding device;
wherein the first turning shaft and the second turning shaft are interacted through a mechanical device so as to form a synchronous turning.

2. The improvement as claimed in claim 1, wherein the first turning shaft and the second turning shaft are interacted through a gear set so as to form a synchronous turning.

3. The improvement as claimed in claim 2, wherein the first turning shaft and the second turning shaft respectively have a first gear and a second gear, which are mutually meshed for forming the synchronous turning.

4. The improvement as claimed in claim 2, wherein the first turning shaft and the second turning shaft respectively have a first gear and a second gear, which are interacted through the gear so as to form the synchronous turning.

5. The improvement as claimed in claim 1, wherein the first turning shaft and the second turning shaft are interacted through a belt pulley set or a sprocket set so as to form a synchronous turning.

6. The improvement as claimed in claim 1, wherein the first turning shaft and the second turning shaft have a synchronous turning in the same direction.

7. The improvement as claimed in claim 1, wherein the first turning shaft and the second turning shaft have a synchronous turning in the opposite direction.

8. An improvement of the heavy window covering, comprising:
an upper elongated member, being a hollow rectangular elongated member seat;
a lower elongated member, being a hollow rectangular elongated member seat separately mounted below the upper elongated member;
an electric transmission module, mounted inside the upper elongated member and comprising a motor and a decelerate set, which has a first transmission wheel;
an auto folding device mounted inside the upper elongated member and comprising a folding spring set, which has a second transmission wheel; and
a blind-rope set, mounted between the upper elongated member and the lower elongated member and comprising blinds connected to the upper elongated member and the lower elongated member, and a rope set whose one end is connected to the lower elongated member and the other end is stretched into the auto folding device; and
wherein the first transmission wheel and the second transmission wheel are connected through a connecting element so as to form a synchronous turning.

9. The improvement as claimed in claim 8, wherein the first transmission wheel and the second transmission wheel are belt pulleys or sprockets and the connecting element is a belt or a chain.

10. The improvement as claimed in claim 8, wherein the first transmission wheel and the second transmission wheel are gears and the connecting element is a gear.
